(19) United States
(12) Patent Application Publication
(10) Pub. No.: US 2010/0250857 A1
(43) Pub. Date: Sep. 30, 2010

(54) CACHE CONTROLLING APPARATUS, INFORMATION PROCESSING APPARATUS AND COMPUTER-READABLE RECORDING MEDIUM ON OR IN WHICH CACHE CONTROLLING PROGRAM IS RECORDED

(75) Inventor: Noriyuki MATSUI, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/710,349

(22) Filed: Feb. 22, 2010

(30) Foreign Application Priority Data
Mar. 30, 2009 (JP) 2009-081888

(51) Int. Cl. G06F 12/08; G06F 12/00

(52) U.S. Cl. 711/133; 711/142; 711/141; 711/E12.001; 711/E12.026; 711/E12.022

(57) ABSTRACT

A technique for managing a cache memory for temporarily retaining data read out from a main memory so as to be used by a processing section is disclosed. The cache memory is managed using a tag memory and utilized by a write-through method. The cache controlling apparatus includes a supervising section adapted to supervise accessing time to the cache memory, and a refreshing section adapted to read out data on one or more cache lines of the cache memory from the main memory again in response to a result of the supervision by the supervising section and retain the read out data into the cache memory.

### CROSS-REFERENCE TO RELATED APPLICATION

This application is based upon and claims the benefit of priority of the prior Japanese Application No. 2009-081888 filed on Mar. 30, 2009 in Japan, the entire contents of which are hereby incorporated by reference.

### FIELD

The embodiments discussed herein are related to a technique for managing a cache memory for temporarily retaining data read out from a main memory so as to be used by a processing section.

### BACKGROUND

Generally, in an information processing system which includes a cache memory, a processing section such as a CPU (Central Processing Unit) reads out data of an accessing object from a main memory into a cache memory and accesses the readout data in the cache memory. Where the cache memory is used, the accessing time from the CPU is reduced. In such a system as described above, usually the cache memory is formed, for example, from an SRAM (Static Random Access Memory) while the main memory is formed, for example, from a DRAM (Dynamic Random Access Memory).

As a utilization method of such a cache memory as described above, a write-back method and a write-through method are known. The write-back method is a method wherein, even if data retained in the cache memory is rewritten, rewriting of corresponding data in the main memory is not carried out immediately, but data of the cache memory are written back collectively into the main memory later. On the other hand, the write-through method is a method wherein, where data retained in the cache memory is rewritten, also rewriting of corresponding data in the main memory is carried out simultaneously. Accordingly, in a system which adopts the write-through method, the state wherein the data in the cache memory and corresponding data in the memory are the same is always maintained.

Incidentally, there is a tendency in recent years that a soft error of an SRAM caused by neutrons and so forth is increasing together with the refinement of a process as disclosed, for example, in Patent Document 1 specified hereinbelow, and an influence of the soft error on the reliability of a system is getting conspicuous.

In a DRAM used as the main memory, if a bit error occurs with retained data, detection and correction of the bit error are carried out usually by an error detection correction circuit called ECC (Error Check and Correct; Error Correction Code) circuit. The ECC makes it possible to carry out correction of a 1-bit error and detection of a 2-bit error in the main memory, and the reliability against a soft error is maintained.

On the other hand, in an SRAM used as the cache memory, although it is necessary to make it possible to execute accessing at a high speed from a CPU, since fixed time is required for the error detection/correction by the ECC, if the ECC is adopted, then the high-speed operation is sacrificed. Accordingly, for the cache memory, only the error detection by a parity method by which high speed arithmetic operation can be carried out is adopted. With such a parity method as just described, only 1-bit errors are detected using parity bits. However, a multi-bit error by two or more bits cannot be detected, and there is the possibility that malfunction of the system may be invited. In short, a cache memory which adopts only the parity method cannot maintain the reliability against a soft error. It is to be noted that, if a 1-bit error is detected in a cache memory, data from which the error is detected is abandoned from the cache memory, and corresponding data is reloaded newly from the main memory.

As a countermeasure against a soft error of a cache memory which is utilized by the write-back method, such a technique as disclosed, for example, in Patent Document 2 specified hereinbelow has been proposed. In the cache memory of the write-back method, even if rewriting of data is carried out, the data is not written back into the main memory immediately. Therefore, the retention time of data is long and the data are likely to be influenced by a soft error. Therefore, in the technique disclosed in Patent Document 2, data in a cache memory of the write-back method whose frequency of use is low is written back efficiently into the main memory so that the data is retained by the main memory which has high reliability thereby to decrease the influence of a soft error on the system.

[Patent Document 1] Japanese Patent Laid-Open Publication No. 2007-59042

[Patent Document 2] Japanese Patent Laid-Open Publication No. 2005-92311

However, in a cache memory of any of the write-back method and the write-through method, since data whose frequency of use is high are retained for a long period of time in the cache memory, a soft error (bit error) is caused by neutrons and so forth with high possibility. Although, in the cache memory (SRAM), a 1-bit error is detected by the parity method and eliminated by reloading of pertaining data from the main memory, the cache memory (SRAM) cannot cope with a multi-bit error of two or more bits and there is the possibility that malfunction of the system may be invited.

### SUMMARY

According to an aspect of the embodiment, there is provided a cache controlling apparatus for managing a cache memory for temporarily retaining data read out from a main memory so as to be used by a processing section using a tag memory, and for utilizing the cache memory by a write-through method, comprising a supervising section adapted to supervise accessing time to the cache memory, and a refreshing section adapted to readout data on one or more cache lines of the cache memory from the main memory again in response to a result of the supervision by the supervising section, and retain the read out data into the cache memory.

According to another aspect of the embodiment, there is provided an information processing apparatus comprising a processing section, a main memory, a cache memory adapted to temporarily retain data read out from the main memory so as to be used by the processing section, a tag memory adapted to manage cache lines of the cache memory, and a cache controlling section adapted to manage the cache memory using the tag memory and utilize the cache memory by a write-through method, and wherein the cache controlling section includes a supervising section adapted to supervise accessing time to the cache memory, and a refreshing section adapted to read out data on one or more cache lines of the cache memory from the main memory again and retain the read out data into the cache memory in response to a result of the supervision by the supervising section, and retain the read out data into the cache memory.

According to a further aspect of the embodiment, there is provided a computer-readable recording medium on or in which a cache controlling program for causing a computer to function as a cache controlling apparatus for managing a cache memory for temporarily retaining data read out from a main memory so as to be used by a processing section using a tag memory and for utilizing the cache memory by a write-through method is recorded, the cache controlling program causing the computer to function as a supervising section adapted to supervise accessing time to the cache memory, and a refreshing section adapted to read out data on one or more cache lines of the cache memory from the main memory again in response to a result of the supervision by the supervising section, and retain the read out data into the cache memory.

The above and other objects, features and advantages of the present invention will become apparent from the following description and the appended claims, taken in conjunction with the accompanying drawings in which like parts or elements are denoted by like reference characters.

### BRIEF DESCRIPTION OF THE DRAWINGS

FIG. 1 is a block diagram illustrating a configuration of an information processing apparatus having a cache controlling apparatus of a first embodiment;

FIG. 2 is a flow chart illustrating operation of the information processing apparatus of FIG. 1;

FIG. 3 is a block diagram illustrating a configuration of an information processing apparatus having a cache controlling apparatus of a second embodiment;

FIG. 4 is a flow chart illustrating operation of the information processing apparatus of FIG. 3;

FIG. 5 is a block diagram illustrating a configuration of an information processing apparatus having a cache controlling apparatus of a third embodiment;

FIG. 6 is a flow chart illustrating operation of the information processing apparatus of FIG. 5;

FIG. 7 is a block diagram illustrating a configuration of an information processing apparatus having a cache controlling apparatus of a fourth embodiment; and

FIG. 8 is a flow chart illustrating operation of the information processing apparatus of FIG. 7.

### DESCRIPTION OF THE PREFERRED EMBODIMENTS

In the following, embodiments are described with reference to the drawings.

### [1] First Embodiment

### [1-1] Configuration of the First Embodiment

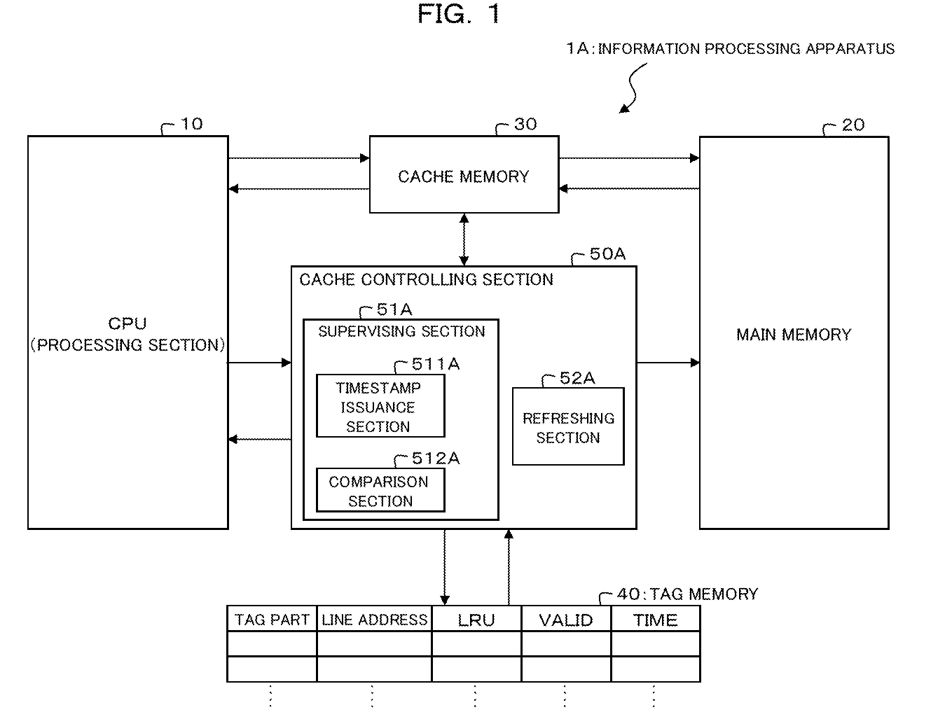

FIG. 1 is a block diagram illustrating a configuration of an information processing apparatus which incorporates a cache controlling apparatus of a first embodiment. Referring to FIG. 1, the information processing apparatus 1A of the first embodiment includes a CPU 10, a main memory 20, a cache memory 30, a tag memory 40, and a cache controlling section (cache controlling apparatus) 50A.

The CPU (processing section) 10 is connected to the main memory 20 through the cache memory 30 and the cache controlling section 50A, and reads out data of an object of accessing from the main memory 20 into the cache memory 30 and carries out accessing to the read out data. In particular, the CPU 10 accesses the cache memory 30 as an object of accessing (reading/writing) and carries out data transfer between the main memory 20 and the cache memory 30 in a unit of a cache line, for example, for 64 bytes.

It is to be noted that, as described hereinabove, the main memory 20 is formed, for example, from a DRAM and the cache memory 30 is formed, for example, from an SRAM. In the main memory 20, error correction by an error detection correction circuit (ECC) described hereinabove is carried out, and in the cache memory 30, error detection by a parity method described hereinabove is carried out.

The tag memory (tag array) 40 has an area for storing management information for managing data temporarily retained in the cache memory 30 for each cache line (tag entry). The tag memory 40 retains, for each cache line, a tag part, a line address, LRU (Least Recently Used) information, a VALID bit, and time stamp information (TIME).

Here, the tag part is a high-order address (a plurality of higher order bits of an address, address data of the main memory 20) of data in each cache line, and the line address is a low-order address (a plurality of lower order bits of the address) other than the tag part. Meanwhile, the LRU information is information for specifying data (cache line) which has not been accessed for the longest period of time, and the VALID bit is a bit to which “1” is set when data of the corresponding cache line is valid but “0” is set when the data is invalid. Further, the time stamp information (TIME) is a timestamp issued to the corresponding cache line by a timestamp issuance section 511A hereinafter described.

The cache controlling section 50A manages the cache memory (data array) 30 using the management information of the tag memory 40 to utilize the cache memory 30 (data array) by the write-through method. If the cache controlling section 50A receives memory accessing from the CPU 10, then it extracts a high-order address from the address of the access object data and searches for a tag part regarding a cache line (valid cache line) to whose VALID bit is set to “1” using the higher order address as a key.

If a tag part which coincides with the extracted high-order address is registered in the tag memory 40 (in the case of cache hit), then the cache controlling section 50A transfers data of the cache memory 30 corresponding to the cache line which has the tag part to the CPU 10. Consequently, accessing to the access object data is carried out by the CPU 10. At this time, if rewriting of data is carried out as the memory accessing, then the same rewriting is also carried out for corresponding data in the main memory 20.

On the other hand, if a tag part which coincides with the extracted high-order address is not registered in the tag memory 40 (in the case of a cache miss), then the cache controlling section 50A reads out the accessing object data from the main memory 20 into the cache memory 30 and transfers the read out data to the CPU 10. Consequently, accessing to the accessing object data is carried out by the CPU 10. At this time, the data from the main memory 20 is written into a cache line (invalid cache line) whose VALID bit is set to “0” or that cache line which has not been accessed for the longest period of time through reference to the LRU information. Further, also at this time, when rewriting of data is to be carried out as memory accessing, same rewriting is carried out also for the corresponding data of the main memory 20.

Further, the cache controlling section 50A has also a function of abandoning, when a parity error (1-bit error) is detected in the cache memory 30, the data from which the error is detected, and loading corresponding data newly into the cache memory 30 from the main memory 20.

The cache controlling section 50A of the first embodiment carries out such basic controlling operations as described above, and besides, has functions as a supervising section 51A and a refreshing section 52A.

The supervising section 51A supervises the cache memory 30 (with regard to the accessing time (present time) to the cache memory 30, data retention time into the cache memory 30 and so forth). The supervising section 51A in the first embodiment has functions as a timestamp issuance section 511A and a comparison section 512A.

The timestamp issuance section 511A issues, when it reads out data from the main memory 20 and retains the data into the cache memory 30 as described above, a timestamp representative of the retention time of the data into a cache line of the cache memory 30 which is a retention destination. Then, the timestamp issuance section 511A writes the timestamp into the TIME of the corresponding cache line of the tag memory 40. It is to be noted that, in order to allow the timestamp issuance section 511A to issue retention time, the timestamp issuance section 511A or the cache controlling section 50A has a clock function of counting and outputting time information representing the present time.

The comparison section 512A carries out the following comparison process at a point of time at which it is recognized based on the tag part (tag information) in the tag memory 40 that the memory accessing object data of the CPU 10 is retained in the tag memory 40, that is, at a point of a cache hit. In particular, the comparison section 512A reads out the timestamp regarding the cache line in which the object data is retained from the tag memory 40 and compares the retention time represented by the timestamp and the present time obtained by the clock function or the like (actually the accessing time or the cache hit recognition time) with each other. Then, the comparison section 512A outputs, as a supervision result by the supervising section 51A, whether or not the accessing time/cache hit recognition time elapses by more than predetermined time T after the retention time, that is, the accessing time/cache hit recognition time elapses time obtained by adding the predetermined time T to the retention time. It is to be noted that the predetermined time T is calculated in advance, for example, in accordance with a calculation expression hereinafter given and registered into and retained in the storage section in the cache controlling section 50A in advance.

The refreshing section 52A carries out a refreshing process of reading out data in one or more cache lines of the cache memory 30 from the main memory 20 and retaining the data into the cache memory 30 in response to a result of the supervision by the supervising section 51A. More particularly, the refreshing section 52A carries out a refreshing process of reading out, when the supervision result from the supervising section 51A indicates that the accessing time (cache hit recognition time) elapses by more than the predetermined time T after the storage time, accessing object data in the corresponding one cache line from the main memory 20 again and retaining the data into the cache memory 30. In other words, although, at this time, a cache hit decision is made with regard to the accessing object data, also in the case of a cache hit, the refreshing section 52A carries out operation similar to that carried out in the case of a cache miss with regard to the accessing object data.

In particular, the cache controlling section 50A in the first embodiment recognizes that the possibility that a soft error may have been caused by neutrons or the like is high where the accessing object data is retained for more than the predetermined time T in the cache memory 30. Then, the accessing object data is reloaded from the main memory 20 in response to the recognition just described.

Here, the predetermined time T is a time interval shorter than a fixed soft error occurrence period time T (MTBF: Mean Time Between Failures). In particular, the predetermined time T is set as a time interval shorter than the time (time constant; data destruct time) τ before latchup of a thyristor structure which parasitically exists in a CMOS structure of memory cells of the cache memory 30 and is activated by neutrons destructs the data in the memory cells.

Such data destruct time τ is calculated based on the node capacitance C of the memory cells for retaining data and the resistance value R of the diffused resistance through which leak current I passes when latchup occurs with the thyristor structure.

In short, the accumulated charge Q of the memory cells can be represented by the following expression (1) using the power supply voltage V and the node capacitance C:

Q=CV (1)

Meanwhile, the accumulated charge Q can be represented as an integration value of the leak current I by a latchup phenomenon by the thyristor structure as represented by the following expression (2):

Q=∫Idt (2)

Here, if ∫dt in the expression (2) is rewritten as “τ”, then the following expression (3) can be obtained, and accordingly, this “τ” can be regarded as representing data destruct time.

Q=Iτ (3)

Then, the following expression (4) applies from the expressions (1) and (3) above:

CV=Iτ (4)

Incidentally, since the leak current I can be represented by the following expression (5) using the resistance value R of the diffused resistance, the following expression (6) can be obtained by substituting the following expression (5) into the expression (4) given above:

I=V/R (5)

CV=(V/R)τ (6)

By solving the expression (6) for the data destruct time τ, the following expression (7) can be obtained, and the calculation section 21a calculates the data destruct time τ based on the expression (7) below:

τ=CR (7)

Then, a time interval shorter than the data destruct time τ calculated in accordance with the expression (7) is set as the predetermined time T described hereinabove.

### [1-2] Operation of the First Embodiment

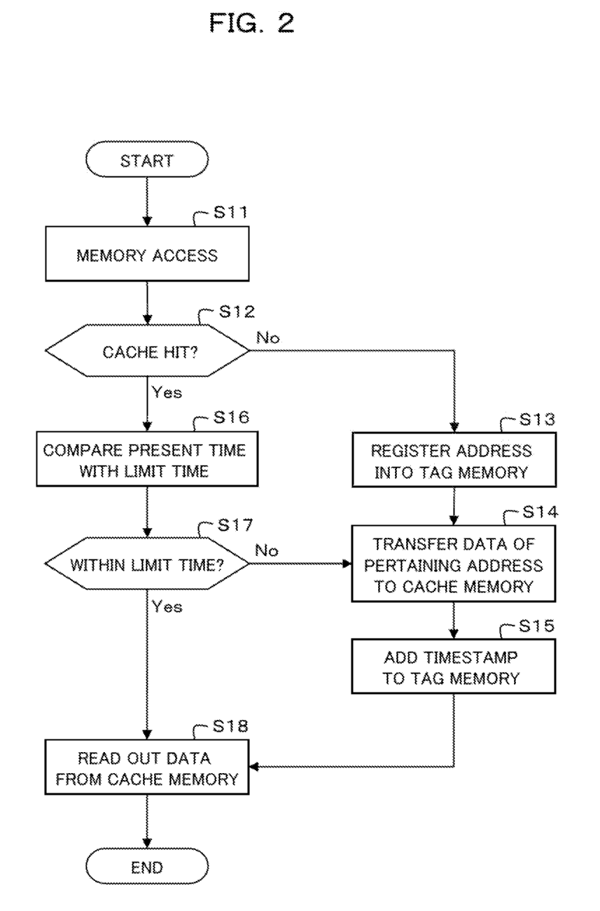

Now, operation of the information processing apparatus 1A having the cache controlling section 50A according to the first embodiment having such a configuration as described above is described with reference to a flow chart (steps S11 to S18) illustrated in FIG. 2.

If the cache controlling section 50A undergoes a memory accessing from the CPU 10 (step S11), then it extracts a high-order address from an address of accessing object data. Then, the cache controlling section 50A uses the high-order address as a key to search the tag memory 40 for the tag part of a cache line (valid cache line) whose VALID bit is set to “1”.

If a result of the search indicates that a tag part which coincides with the extracted higher order address is not registered in the tag memory 40 (in the case of a cache miss; No route of step S12), then the cache controlling section 50A registers the address of the accessing object data into the tag part and the line address of the tag memory 40 (step S13). Then, the cache controlling section 50A reads out accessing object data from the main memory 20 into the cache memory 30 and transfers the accessing object data to the cache memory 30 so as to be stored into the cache memory (step S14).

At this time, the timestamp issuance section 511A issues a timestamp representing the retention time of the accessing object data into the cache memory 30 of a retention destination and additionally writes the timestamp as the TIME into the corresponding cache line of the tag memory 40 (step S15). Thereafter, the data readout into the cache memory 30 is transferred as accessing object data from the cache memory 30 to the CPU 10 (step S18). Consequently, accessing to the accessing object data is carried out by the CPU 10.

On the other hand, if the result of the search for the tag part carried out using the higher order address as a key indicates that a tag part which coincides with the extracted higher order address is registered in the tag memory 40 (in the case of a cache hit; Yes route of step S12), the comparison section 512A of the cache controlling section 50A functions. In particular, the comparison section 512A reads out the timestamp regarding the cache line into which the accessing object data is to be retained from the tag memory 40 and decides through comparison whether or not the present time indicates lapse of more than the predetermined time T after the retention time (step S16).

If the present time does not indicate lapse of more than the predetermined time T after the retention time (where the present time is within a limit time period; Yes route at step S17), then the accessing object data retained in the cache memory 30 is transferred from the cache memory 30 to the CPU 10 (step S18). Consequently, accessing to the accessing object data is carried out by the CPU 10.

On the other hand, if the present time indicates lapse of more than the predetermined time T after the retention time (where the present time is outside the limit time period; No route of step S17), then the refreshing section 52A of the cache controlling section 50A functions. In particular, the refreshing section 52A carries out a refreshing process of abandoning the accessing object data retained at present in the cache memory 30 and reading out the accessing object data from the main memory 20 again and then retaining the re-read accessing object data into the cache memory 30 (step S14).

Also at this time, the timestamp issuance section 511A issues a timestamp representing the retention time of the accessing object data into the cache memory 30 of a retention destination and additionally writes the timestamp as the TIME into the corresponding cache line of the tag memory 40 (step S15). Thereafter, the data read out into the cache memory 30 is transferred as accessing object data from the cache memory 30 to the CPU 10 (step S18). Consequently, accessing to the accessing object data is carried out by the CPU 10.

### [1-3] Effects of the First Embodiment

In this manner, with the information processing apparatus 1A having the cache controlling section 50A according to the first embodiment, even if a cache hit occurs in regard to accessing object data, if the data remains retained in the cache memory 30 exceeding the predetermined time T, a process similar to that in the case of a cache miss is carried out. In particular, where accessing object data remains retained in the cache memory 30 exceeding the predetermined time T, the information processing apparatus 1A recognizes that the possibility that a soft error may be caused by neutrons or the like is high, and the accessing object data is reloaded into the cache memory 30 from the main memory 20.

In the main memory 20, the latest data is always retained in a state wherein it is protected by an ECC or the like. Accordingly, data of the cache memory 30 whose retention time in the cache memory 30 is so long that the data may have been destroyed by a soft error as described above is reloaded/refreshed with highly reliable corresponding data of the main memory 20. Consequently, soft errors in the cache memory 30 are relieved and the probability of occurrence of soft errors decreases, and occurrence of a malfunction arising from a soft error in a system (CPU 10) which uses the cache memory 30 can be suppressed with certainty.

### [2] Second Embodiment

### [2-1] Configuration of the Second Embodiment

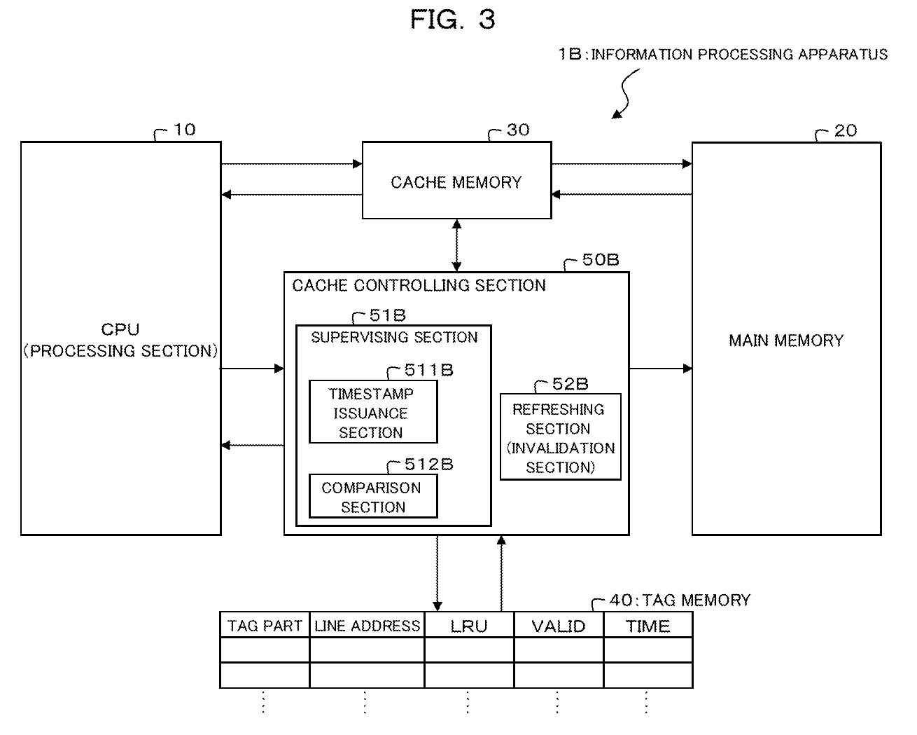

FIG. 3 is a block diagram illustrating a configuration of an information processing apparatus having a cache controlling apparatus of a second embodiment. As illustrated in FIG. 3, the information processing apparatus 1B of the second embodiment has a CPU 10, a main memory 20, a cache memory 30, and a tag memory 40 similar to those of the first embodiment and further has a cache controlling section (cache controlling apparatus) 50B in place of the cache controlling section 50A of the first embodiment. It is to be noted that, in FIG. 3, like reference characters to those referred to hereinabove denote like or substantially like elements, and therefore, overlapping description of them is omitted herein.

Also the cache controlling section 50B of the second embodiment carries out basic controlling operations similar to those of the cache controlling section 50A of the first embodiment and additionally has functions as a supervising section 51B and a refreshing section 52B.

Also the supervising section 51B supervises the cache memory 30 (such as accessing time (present time) to the cache memory 30, data retention time into the cache memory 30 and so forth) similarly to the supervising section 51A. The supervising section 51B of the second embodiment functions as a timestamp issuance section 511B and a comparison section 512B.

The timestamp issuance section 511B functions similarly to the timestamp issuance section 511A of the first embodiment. In particular, also the timestamp issuance section 511B issues, when data is read out from the main memory 20 and retained into the cache memory 330, a timestamp representing the retention time into a cache line of the cache memory 30 which is a retention destination of the pertaining data. Then, the timestamp issuance section 511B writes the timestamp into the TIME of the corresponding cache line of the tag memory 40. It is to be noted that, in order to allow the timestamp issuance section 511B to issue the retention time, the timestamp issuance section 511B or the cache controlling section 50B has a clock function of counting and outputting time information representing the present time.

The comparison section 512B carries out a comparison process similar to that of the comparison section 512A of the first embodiment at a point of time of a cache hit and besides, carries out such a comparison process as described below in the second embodiment, for example, when prescribed time set in advance comes. In particular, when the prescribed time comes, the comparison section 512B reads out the timestamp for each cache line regarding all data retained in the cache memory 30 from the tag memory 40 and compares the retention time represented by each timestamp and the present time (comparison execution time) obtained from the clock function described above or the like with each other. Then, the comparison section 512B outputs, as a result of the supervision by the supervising section 51B, whether or not the comparison execution time indicates lapse by predetermined time T or more than the predetermined time T after the retention time, that is, whether or not time obtained by addition of the predetermined time T to the retention time elapses. It is to be noted that the predetermined time T is calculated, for example, in such a manner as described hereinabove in connection with the first embodiment and is registered and retained in advance in a storage section of the cache controlling section 50B. Further, the prescribed time described above may be set at random or may be set cyclically. This prescribed time is registered and retained in advance, for example, in the storage section in the cache controlling section 50B similarly to the predetermined time T.

The refreshing section 52B carries out a refreshing process of reading out data in one or more cache lines of the cache memory 30 from the main memory 20 again in response to a result of supervision by the supervising section 51B and retaining the read-out data into the cache memory 30 similarly to the refreshing section 50A in the first embodiment. More particularly, also the refreshing section 52B of the second embodiment carries out a refreshing process of re-reading out, where the supervision result from the supervising section 51B indicates that the accessing time (cache hit recognition time) indicates lapse by the predetermined time T or more than the predetermined time T after the retention time, accessing object data of a corresponding one cache line from the main memory 20 and retaining the read out data into the cache memory 30 similarly to the refreshing section 52A of the first embodiment. In other words, although a cache hit decision has been made with regard to the pertaining accessing object data, where such a case appears even in the case of a cache hit, the refreshing section 52B carries out operation equivalent to that carried out upon a cache miss with regard to the pertaining accessing object data.

Further, where the supervision result from the supervising section 51B indicates that the comparison execution time indicates lapse by the predetermined time T or more than the predetermined time T after the retention time, the refreshing section 52B of the second embodiment functions as an invalidation section for invalidating the pertaining cache line. In particular, the refreshing section 52B sets the VALID bit of the tag memory 40 to “0” to invalidate the pertaining line. Consequently, if data retained in the pertaining cache line becomes object data of memory accessing of the CPU 10 after the invalidation process, then a cache miss decision is made in regard to the pertaining data and the corresponding data is read out from the main memory 20 again similarly as in the first embodiment. In particular, the corresponding data is read out newly from the main memory 20 and retained into the cache memory 30 and management information regarding the data is registered into the tag memory 40. Where the refreshing section 52B invalidates the pertaining cache line in such a manner as described above, the data in the pertaining cache line is substantially reloaded/refreshed. At this time, a timestamp indicative of the retention time is issued by the timestamp issuance section 511B and written into a corresponding cache line of the tag memory 40 similarly as in the first embodiment.

### [2-2] Operation of the Second Embodiment

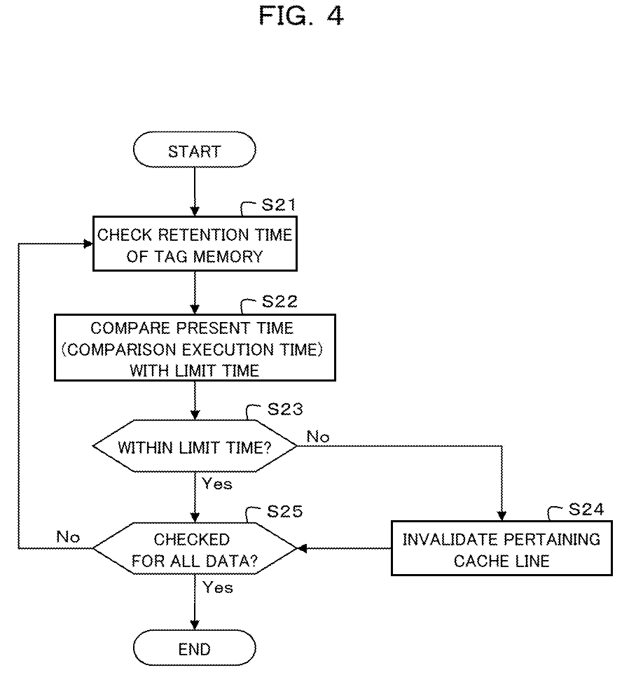

Now, operation of the information processing apparatus 1B having the cache controlling section 50B of the second embodiment configured in such a manner as described above is described with reference to a flow chart (steps S21 to S25) illustrated in FIG. 4. It is to be noted that, if the cache controlling section 50B receives memory accessing from the CPU 10, then it operates in accordance with the flow chart (steps S11 to S18) illustrated in FIG. 2 similarly to the cache controlling section 50A of the first embodiment.

On the other hand, in the cache controlling section 50B of the second embodiment, when memory accessing from the CPU 10 is received or if the present time obtained by the clock function described hereinabove indicates the prescribed time set in advance, then the comparison section 512B of the cache controlling section 50B functions. In particular, the comparison section 512B reads out the timestamp corresponding to one cache line from the tag memory 40 (step S21) and decides by comparison whether or not the comparison execution time (present time) indicates lapse by the predetermined time T or more than the predetermined time T after the retention time (step S22).

If the comparison execution time indicates lapse by the predetermined time T or more than the predetermined time T after the retention time (if the present time is outside the limit time; No route of step S23), then the refreshing section 52B of the cache controlling section 50B functions. In particular, the refreshing section (invalidation section) 52B sets the VALID bit of the tag memory 40 corresponding to the pertaining data (cache line) which has been retained in the cache memory 30 for the predetermined time T or more than the predetermined time T to “0” to invalidate the cache line (step S24).

Consequently, if the data retained in the pertaining cache line becomes object data of memory accessing of the CPU 10 after the invalidation process, then a cache miss decision is made with regard to the data as described hereinabove (refer to the No route of step S12 of FIG. 2). Accordingly, corresponding data is newly read out from the main memory 20 and retained into the cache memory 30, and management information (address, timestamp and so forth) regarding the data is registered into the tag memory 40 (refer to steps S14, S15 and S18 of FIG. 2). By such an invalidation process as just described, the data in the cache line is substantially reloaded/refreshed. Thereafter, the cache controlling section 50B advances its processing to step S25.

On the other hand, if the comparison execution time does not indicate lapse by the predetermined time T or more than the predetermined time T after the retention time (if the present time is within the limit time; Yes route of step S23), then the cache controlling section 50B advances its processing to step S25 without particularly carrying out processing. At step S25, the cache controlling section 50B decides whether or not the check of the retention time has been carried out for all data (cache lines) (step S25). If the check for all data is completed (Yes route), then the cache controlling section 50B ends the processing. On the other hand, if the check is not completed as yet (No route), then the cache controlling section 50B returns its processing to step S21, at which it selects another cache line and carries out processing similar to that described above for this cache line.

### [2-3] Effect of the Second Embodiment

In this manner, with the information processing apparatus 1B having the cache controlling section 50B of the second embodiment, if prescribed time set in advance comes, the timestamp regarding data retained in the cache memory 30 is checked for every cache line. Then, if some data has been retained in the cache memory 30 exceeding the predetermined time T, then the data (cache line) is invalidated and is reloaded/refreshed upon next accessing.

Accordingly, in the second embodiment, a check of the retention time is carried out not only at a point of time of a cache hit but also when the prescribed time comes, and data of the cache memory 30 which may have been destroyed by a soft error are reloaded/refreshed with corresponding data retained in the main memory 20 and hence having high reliability. Consequently, a soft error in the cache memory 30 is relieved and the occurrence probability of a soft error is decreased, and occurrence of malfunction arising from a soft error in a system (CPU 10) which uses the cache memory 30 can be suppressed with certainty.

### [3] Third Embodiment

### [3-1] Configuration of the Third Embodiment

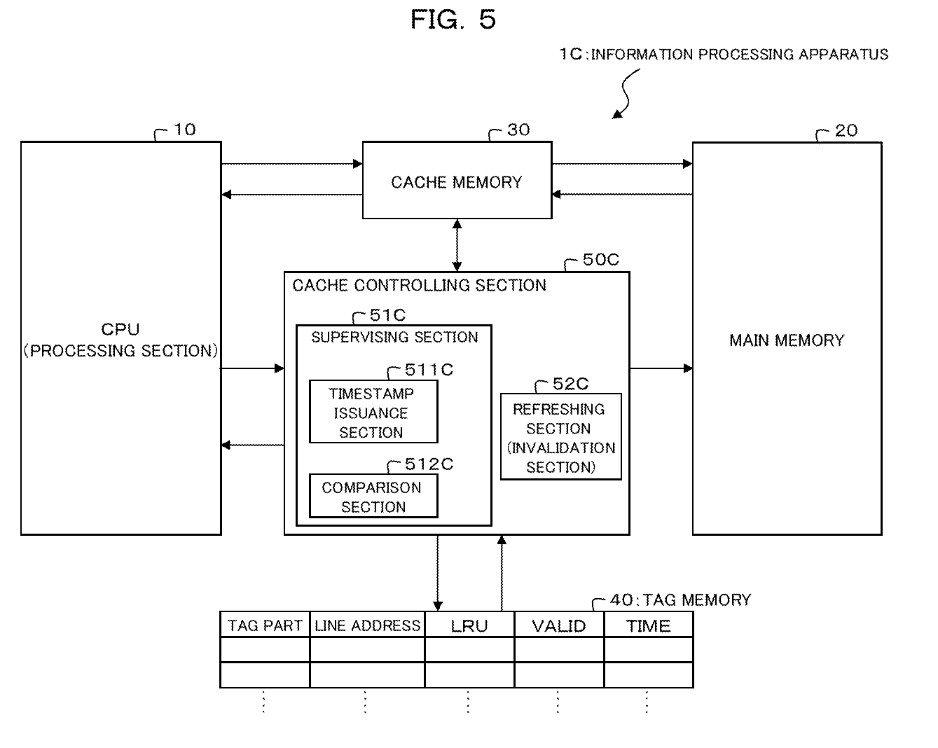

FIG. 5 is a block diagram illustrating a configuration of an information processing apparatus having a cache controlling apparatus of a third embodiment. Referring to FIG. 5, the information processing apparatus 1C of the third embodiment includes a CPU 10, a main memory 20, a cache memory 30, and a tag memory 40, similar to those in the first embodiment and further has a cache controlling section (cache controlling apparatus) 50C in place of the cache controlling section 50A of the first embodiment. It is to be noted that, in FIG. 5, like reference characters to those referred to hereinabove denote like or substantially like elements, and therefore, overlapping description of them is omitted herein.

Also the cache controlling section 50C of the third embodiment carries out basic controlling operations similar to those of the cache controlling section 50A of the first embodiment, and besides, has functions as a supervising section 51C and a refreshing section 52C.

Also the supervising section 51C supervises the cache memory 30 (accessing time (present time) to the cache memory 30, data storage time into the cache memory 30 and so forth) similarly to the supervising section 51A. The supervising section 51C has functions as a timestamp issuance section 511C and a comparison section 512C.

The timestamp issuance section 511C functions similarly to the timestamp issuance section 511A of the first embodiment. In particular, the timestamp issuance section 511C also issues, when data is read out from the main memory 20 and retained into the cache memory 30, a timestamp representing the retention time of the data into a cache line of the cache memory 30 which is a retention destination of the data. Then, the timestamp issuance section 511C writes the timestamp into the TIME of the corresponding cache line of the tag memory 40. It is to be noted that, in order to allow the timestamp issuance section 511C to issue the retention time, the timestamp issuance section 511C or the cache controlling section 50C has a clock function of counting and outputting time information representing the present time.

The comparison section 512C carries out a comparison process similar to that of the comparison section 512A in the first embodiment at a point of time at which a cache hit occurs similarly to the comparison section 512A in the first embodiment.

Meanwhile, the refreshing section 52C carries out a refreshing process of reading out data in one or more cache lines of the cache memory 30 from the main memory 20 again and retaining the read out data into the cache memory 30 in response to a result of the supervision by the supervising section 51C similarly to the refreshing section 50A in the first embodiment. More particularly, the refreshing section 52C also carries out a refreshing process of re-reading out, where the supervision result from the supervising section 51C indicates that the accessing time (cache hit recognition time) indicates lapse by the predetermined time T or more than the predetermined time T after the retention time, accessing object data in a corresponding one cache line of the cache memory 30 from the main memory 20 and retaining the read-out accessing object data into the cache memory 30. In particular, although a cache hit decision has been made in regard to the accessing object data, where such a case appears even in the case of a cache hit, the refreshing section 52C carries out operation equivalent to that carried out upon a cache miss with regard to the pertaining accessing object data.

Further, the refreshing section 52C also functions as an invalidation section for invalidating, where the supervision result from the supervising section 51C indicates that the access time (cache hit recognition time) indicates lapse by the predetermined time T or more than the predetermined time T after the retention time, all of the cache lines other than the cache line for which the refreshing process is carried out. In particular, the refreshing section 52C sets the VALID bit of the tag memory 40 to “0” to invalidate the cache lines. Consequently, if any of the data which have been retained in the invalidated cache lines becomes object data of memory accessing of the CPU 10 after the invalidation process, then a cache miss decision is made with regard to the data, and corresponding data is read out from the main memory 20 again similarly as in the first embodiment. In particular, the pertaining data is readout newly from the main memory 20 and retained into the cache memory 30, and management information regarding the data is registered into the tag memory 40. Since the refreshing section 52C invalidates the pertaining cache line as described above, data in the cache line is substantially reloaded/refreshed. At this time, a timestamp representative of the retention time is issued by the timestamp issuance section 511C and written into the corresponding cache line of the tag memory 40 similarly as in the first embodiment.

### [3-2] Operation of the Third Embodiment

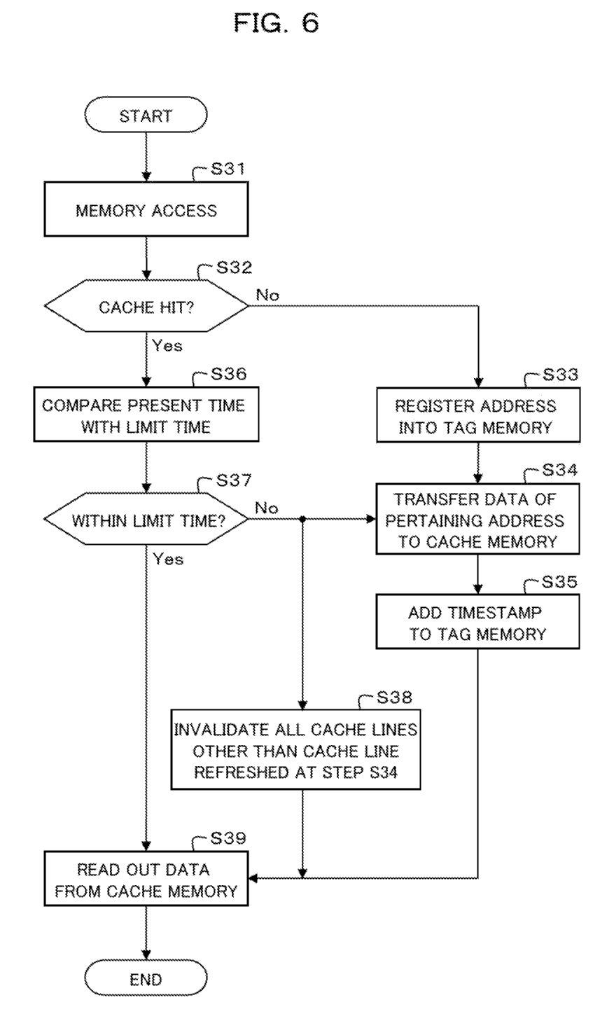

Now, operation of the information processing apparatus 1C having the cache controlling section 50C of the third embodiment having such a configuration as described above is described with reference to a flow chart (steps S31 to S39) illustrated in FIG. 6. It is to be noted that the steps S31 to S37 and S39 basically correspond to the steps S11 to S18 of FIG. 2.

If the cache controlling section 50C undergoes a memory accessing from the CPU 10 (step S31), then it extracts a high-order address from an address of accessing object data. Then, the cache controlling section 50C uses the high-order address as a key to search the tag memory 40 for the tag part of a cache line (valid cache line) whose VALID bit is set to “1”.

If a result of the search indicates that a tag part which coincides with the extracted higher order address is not registered in the tag memory 40 (in the case of a cache miss; No route of step S32), then the cache controlling section 50C registers the address of the accessing object data into the tag part and the line address of the tag memory 40 (step S33). Then, the cache controlling section 50C reads out accessing object data from the main memory 20 into the cache memory 30 and transfers the accessing object data to the cache memory 30 so as to be stored into the cache memory 30 (step S34).

At this time, the timestamp issuance section 511C issues a timestamp representing the retention time of the accessing object data into the cache memory 30 of a retention destination and additionally writes the timestamp as the TIME into the corresponding cache line of the tag memory 40 (step S35). Thereafter, the read-out data into the cache memory 30 is transferred as accessing object data from the cache memory 30 to the CPU 10 (step S39). Consequently, accessing to the accessing object data is carried out by the CPU 10.

On the other hand, if the result of the search for the tag part carried out using the higher order address as a key indicates that a tag part which coincides with the extracted higher order address is registered in the tag memory 40 (in the case of a cache hit; Yes route of step S32), the comparison section 512C of the cache controlling section 50C functions. In particular, the comparison section 512C reads out the timestamp regarding the cache line into which the accessing object data is to be retained from the tag memory 40 and decides through comparison whether or not the present time indicates lapse of more than the predetermined time T after the retention time (step S36).

If the present time does not indicate lapse of more than the predetermined time T after the retention time (where the present time is within a limit time period; Yes route of step S37), then the accessing object data retained in the CPU 10 is transferred from the cache memory 30 to the CPU 10 (step S38). Consequently, accessing to the accessing object data is carried out by the CPU 10.

On the other hand, if the present time indicates lapse of more than the predetermined time T after the retention time (where the present time is outside the limit time period; No route of step S37), then the refreshing section 52C of the cache controlling section 50C functions. In particular, the refreshing section 52A carries out a refreshing process of abandoning the accessing object data retained at present in the cache memory 30 and reading out the accessing object data from the main memory 20 again and then retaining the re-read accessing object data into the cache memory 30 (steps S34 and S35).

Simultaneously, the refreshing section 52C invalidates all cache lines other than the cache line for which the refreshing process has been carried out at step S34 (step S38).

If any of the data which have been retained in the cache lines invalidated in this manner become object data of memory accessing of the CPU 10 after the invalidation, then a cache miss decision is made with regard to the pertaining data (refer to No route of step S32). Accordingly, the pertaining data is newly read out from the main memory 20 and retained into the cache memory 30 and management information (address and timestamp) regarding the data is registered into the tag memory 40 (refer to steps S34, S35 and S39). By such an invalidating process as just described, the data in the pertaining cache line is substantially reloaded/refreshed.

### [3-3] Effect of the Third Embodiment

In this manner, with the information processing apparatus 1C having the cache controlling apparatus 50C of the third embodiment, similar operation and effects to those achieved by the first embodiment can be achieved.

Further, in the third embodiment, if cache hit data remains retained in the cache memory 30 exceeding the predetermined time T, then not only the data is refreshed, but also the cache lines other than the cache line in which the data is retained are invalidated. In particular, if data in one cache line remains retained exceeding the predetermined time T, then it is decided that the possibility that data in the other cache lines may also remain retained exceeding the predetermined time T, that is, may be in a state destroyed by a soft error, and invalidation of all of the other cache lines is carried out.

Accordingly, also in the third embodiment, data of the cache memory 30 which may be in a state destroyed by a soft error is reloaded/refreshed with corresponding data in the main memory 20 which have high reliability. Consequently, a soft error in the cache memory 30 is relieved and the occurrence probability of a soft error is decreased, and occurrence of malfunction arising from a soft error in a system (CPU 10) which uses the cache memory 30 can be suppressed with certainty.

### [4] Fourth Embodiment

### [4-1] Configuration of the Fourth Embodiment

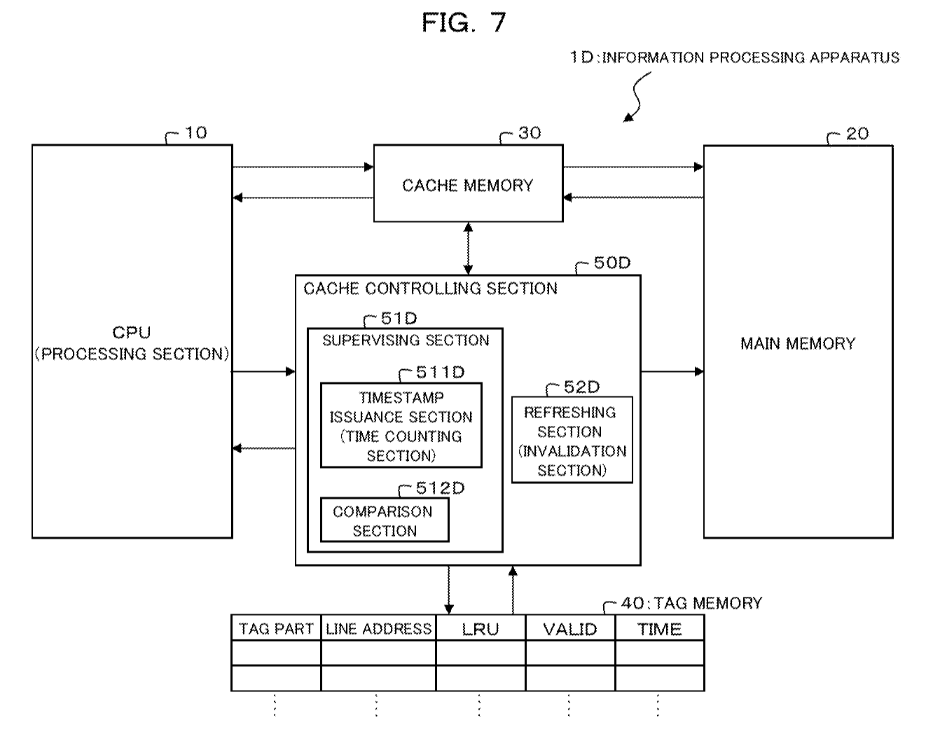

FIG. 7 is a block diagram illustrating a configuration of an information processing apparatus having a cache controlling apparatus of a fourth embodiment. As illustrated in FIG. 7, the information processing apparatus 1D of the fourth embodiment has a CPU 10, a main memory 20, a cache memory 30, and a tag memory 40, similar to those of the first embodiment and further has a cache controlling section (cache controlling apparatus) 50D in place of the cache controlling section 50A of the first embodiment. It is to be noted that, in FIG. 7, like reference characters to those referred to hereinabove denote like or substantially like elements, and therefore, overlapping description of them is omitted herein.

Also the cache controlling section 50D of the fourth embodiment carries out basic controlling operations similar to those of the cache controlling section 50A of the first embodiment and additionally has functions as a supervising section 51D and a refreshing section 52D.

Also the supervising section 51D supervises the cache memory 30 (such as accessing time (present time) to the cache memory 30, data retention time into the cache memory 30 and so forth) similarly to the supervising section 51A. The supervising section 51D of the fourth embodiment functions as a timestamp issuance section (time counting section) 511D and a comparison section 512D.

The timestamp issuance section 511D functions similarly to the timestamp issuance section 511A in the first embodiment and further has a function as a time counting section (clock function/timer) for counting the time. In particular, the timestamp issuance section 511D also issues, when it reads out data from the main memory 20 and retains the data into the cache memory 30, a timestamp representing the retention time of the data into a cache line of the cache memory 30 which is a retention destination of the data. Then, the timestamp issuance section 511D writes the timestamp into the TIME of the corresponding cache line of the tag memory 40. It is to be noted that, in order to allow the timestamp issuance section 511D to issue the retention time, the timestamp issuance section 511D or the cache controlling section 50D has a clock function of counting and outputting time information representing the present time.

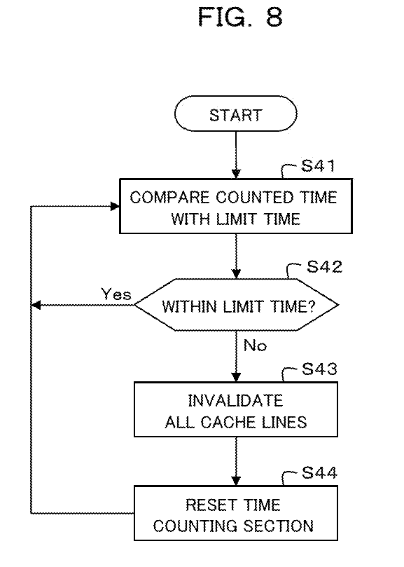

The function of the timestamp issuance section 511D as the time counting section is implemented using the clock function described above. The timestamp issuance section 511D is reset at a timing hereinafter described (refer to step S44 of FIG. 8) and is used by the comparison section 512D hereinafter described to detect whether or not elapsed time after the resetting reaches predetermined time T set in advance.

The comparison section 512D carries out a comparison process similar to that carried out by the comparison section 512A of the first embodiment at a point of time of a cache hit. Further, in the fourth embodiment, the comparison section 512D compares the counted time by the timestamp issuance section 511D and the predetermined time T with each other to detect whether or not the counted time becomes the predetermined time T or more and outputs a result of the detection as a supervision result. It is to be noted that the predetermined time T is calculated, for example, in such a manner as described hereinabove in the description of the first embodiment and registered and retained in advance in a storage section in the cache controlling section 50D.

The refreshing section 52D carries out a refreshing process of reading out data in one or more cache lines of the cache memory 30 from the main memory 20 again and retaining the read out data into the cache memory 30 in response to a result of the supervision by the supervising section 51D similarly to the refreshing section 50A in the first embodiment. More particularly, also the refreshing section 52D carries out a refreshing process of re-reading out, where the supervision result from the supervising section 51D indicates that the accessing time (cache hit recognition time) indicates lapse by the predetermined time T or more than the predetermined time T after the retention time, accessing object data in a corresponding one cache line of the cache memory 30 from the main memory 20 and retaining the read out accessing object data into the cache memory 30. In particular, although a cache hit decision has been made in regard to the accessing object data, where such a case appears even in the case of a cache hit, the refreshing section 52D carries out operation equivalent to that carried out upon a cache miss with regard to the pertaining accessing object data.

Further, the refreshing section 52D of the fourth embodiment functions as an invalidation section which invalidates, if the supervision result from the supervising section 51D indicates that the counted time by the timestamp issuance section 511D is equal to or more than the predetermined time T, all cache lines in the cache memory 30. In particular, the refreshing section 52D sets the VALID bit of the tag memory 40 to “0” to invalidate the cache lines. Consequently, if any of the data retained in the invalidated cache lines become object data of memory accessing of the CPU 10 after the invalidation process, then a cache miss decision is made with regard to the data, and corresponding data is read out from the main memory 20 again similarly as in the first embodiment. In short, the pertaining data is newly readout from the main memory 20 and retained into the cache memory 30 and management information regarding the data is stored into the tag memory 40. Where the refreshing section 52D invalidates the pertaining cache line as described above, the data in the cache line is substantially reloaded/refreshed. At this time, a timestamp representing the retention time is issued by the timestamp issuance section 511D and written into the corresponding cache line of the tag memory 40.

### [4-2] Operation of the Fourth Embodiment

Now, operation of the information processing apparatus 1D having the cache controlling section 50D of the fourth embodiment configured in such a manner as described above is described with reference to a flow chart (steps S41 to S45) illustrated in FIG. 8. It is to be noted that, if the cache controlling section 50D receives memory accessing from the CPU 10, it operates in accordance with the flow chart (steps S11 to S18) illustrated in FIG. 2 similarly to the cache controlling section 50A of the first embodiment.

Meanwhile, in the cache controlling section 50D of the fourth embodiment, the comparison section 512D compares the counted time by the timestamp issuance section 511D and the predetermined time (limit time) T with each other (step S41), and a result of the comparison (supervision result) is outputted to the refreshing section 52D. Then, if the counted time is within the predetermined time T (Yes route of step S42), then the cache controlling section 50D returns its processing to the process at step S41, but if the counted time is equal to or more than the predetermined time T (No route of step S42), then the refreshing section 52D of the cache controlling section 50D functions. In particular, the refreshing section (invalidation section) 52D invalidates all cache lines in the cache memory 30/tag memory 40 (step S43) and resets the timestamp issuance section 511D (step S44), whereafter the cache controlling section 50D returns its processing to the process at step S41.

Thereafter, if any of the data which have been retained in the cache lines invalidated at step S43 as described above become object data of memory accessing of the CPU 10, then a cache miss decision is made with regard to the data (refer to the No route of step S12 of FIG. 2). Accordingly, corresponding data is newly read out from the main memory 20 and retained into the cache memory 30 and management information (address and timestamp) regarding the data is registered into the tag memory 40 (refer to steps S14, S15 and S18 of FIG. 2). By such an invalidating process as just described, the data in the cache line is substantially reloaded/refreshed.

### [4-3] Effect of the Fourth Embodiment

In this manner, with the information processing apparatus 1D having the cache controlling section 50D of the fourth embodiment, it is presupposed that, if the predetermined time T elapses, then the possibility that data in the cache memory 30 may be in a state destroyed by a soft error becomes high. Based on the presupposition, every time the predetermined time T which is a shorter time interval than the soft error occurrence period τ elapses, all cache lines of the cache memory 30 are invalidated.

Accordingly, also in the fourth embodiment, data of the cache memory 30 which may have been destroyed by a soft error is reloaded/refreshed with corresponding data in the main memory 20 which has high reliability. Consequently, a soft error in the cache memory 30 is relieved and the occurrence probability of a soft error is decreased, and occurrence of malfunction arising from a soft error in a system (CPU 10) which uses the cache memory 30 can be suppressed with certainty.

### [5] Others

It is to be noted that the present invention is not limited to the embodiments described above but can be carried out by modifying the embodiments described above in various manners without departing from the spirit and scope of the present invention.

Further, some or all of the functions as the supervising sections 51A to 51D (timestamp issuance sections 511A to 511D and comparison sections 512A to 512D) and the refreshing sections 52A to 52D described hereinabove are implemented by executing a predetermined application program (cache controlling program) by means of computers including CPUs, information processing apparatus, and various terminals.

The program is provided in a form wherein it is recorded on or in a computer-readable recording medium such as, for example, a flexible disk, a CD (CD-ROM, CD-R, CD-RW or the like), a DVD (DVD-ROM, DVD-RAM, DVD-R, DVD-RW, DVD+R, DVD+RW, blue ray disk or the like) or the like. In this instance, a computer reads the program from the recording medium and transfers and stores the program to and into an internal storage apparatus or an external storage apparatus.

Here, the computer signifies a concept including hardware and an OS and signifies hardware which operates under the control of the OS. Further, where an OS is unnecessary and hardware is operated singly with an application program, the hardware itself corresponds to the computer. The hardware includes at least a microprocessor such as a CPU and a means for reading the computer program recorded on or in the recording medium. The program includes program codes which cause such a computer as described above to implement the functions as the supervising sections 51A to 51D and the refreshing sections 52A to 52D. Further, some of the functions may be implemented not by an application program but by an OS.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments have been described in detail, it should be understood that the various changes, substitutions, and alterations could be made hereto without departing from the spirit and scope of the invention.

What is claimed is:

1. A cache controlling apparatus for managing a cache memory for temporarily retaining data read out from a main memory so as to be used by a processing section using a tag memory, and for utilizing said cache memory by a write-through method, comprising:
a supervising section adapted to supervise accessing time to said cache memory; and
a refreshing section adapted to read out data on one or more cache lines of said cache memory from said main memory again in response to a result of the supervision by said supervising section, and retain the read out data into said cache memory.

2. The cache controlling apparatus as claimed in claim 1, wherein said supervising section includes:
a timestamp issuance section adapted to write, when data is read out from said main memory and retained into said cache memory, a timestamp indicative of retention time of the data on the cache line or lines of said cache memory, which are a retention destination of the data, into said tag memory; and
a comparison section adapted to compare, at a point of time at which it is recognized based on tag information in said tag memory that target data of memory accessing by said processing section is retained in said cache memory, the retention time indicated by the timestamp regarding the cache line or lines which retain the target data and the present time with each other, and output, as a result of the supervision, a result of the comparison regarding whether or not the present time indicates lapse by predetermined time or more than the predetermined time after the retention time, and
where the supervision result from said supervising section indicates that the present time indicates lapse by the predetermined time or more than the predetermined time after the retention time, said refreshing section reads out the target data on the cache line or lines from said main memory again and retains the read out target data into said cache memory.

3. The cache controlling apparatus as claimed in claim 1, wherein said supervising section includes:
a timestamp issuance section adapted to write, when data is read out from said main memory and retained into said cache memory, a timestamp indicative of retention time of the data on the cache line or lines of said cache memory, which are a retention destination of the data, into said tag memory; and
a comparison section adapted to compare the retention time indicated by the timestamp regarding each cache line of said cache memory and the present time with each other and output, as a result of the supervision, a result of the comparison regarding whether or not the present time indicates lapse by predetermined time or more than the predetermined time after the retention time, and
where the supervision result from said supervising section indicates that the present time indicates lapse by the predetermined time or more than the predetermined time after the retention time, said refreshing section reads out the data on the cache line from said main memory again and retains the readout data into said cache memory.

4. The cache controlling apparatus as claimed in claim 3, wherein, where the supervision result from said supervising section indicates that the present time indicates lapse by the predetermined time or more than the predetermined time after the retention time, said refreshing section invalidates the cache line.

5. The cache controlling apparatus as claimed in claim 1, wherein said supervising section includes:
a timestamp issuance section adapted to write, when data is read out from said main memory and retained into said cache memory, a timestamp indicative of retention time of the data on the cache line or lines of said cache memory, which are a retention destination of the data, into said tag memory; and
a comparison section adapted to compare, at a point of time at which it is recognized based on tag information in said tag memory that the target data of memory accessing by said processing section is retained in said cache memory, the retention time indicated by the timestamp regarding the cache line or lines which retain the target data and the present time with each other, and output, as a result of the supervision, a result of the comparison regarding whether or not the present time indicates lapse by predetermined time or more than the predetermined time after the retention time, and
where the supervision result from said supervising section indicates that the present time indicates lapse by the predetermined time or more than the predetermined time after the retention time, said refreshing section reads out the target data on the cache line or lines from said main memory again and retains the read out target data into said cache memory and then invalidates all cache lines other than the cache line.

6. The cache controlling apparatus as claimed in claim 1, wherein said supervising section includes:
a time counting section adapted to count time; and
a comparison section adapted to compare the counted time by said time counting section and predetermined time with each other and output, as a result of the supervision, a result of the comparison regarding whether or not the counted time is equal to or longer than the predetermined time, and
where the supervision result from said supervising section indicates that the counted time is equal to or longer than the predetermined time, said refreshing section invalidates all cache lines of said cache memory.

7. The cache controlling apparatus as claimed in claim 2, wherein said cache memory is a static random access memory, and said refreshing section operates to prevent data in memory cells of said SRAM from being destroyed by a soft error by neutrons.

8. The cache controlling apparatus as claimed in claim 7, wherein the predetermined time used as a comparison reference by said comparison section is a time interval shorter than data destruct time before the data is destroyed by latchup of a thyristor structure which parasitically exists in a structure of the memory cells and is activated by the neutrons.

9. The cache controlling apparatus as claimed in claim 8, wherein the data destruct time is calculated based on node charge of the memory cells which retain the data and a resistance value of resistance through which leak current passes in the thyristor structure.

10. An information processing apparatus, comprising:
a processing section;
a main memory;
a cache memory adapted to temporarily retain data read out from said main memory so as to be used by said processing section;
a tag memory adapted to manage cache lines of said cache memory; and
a cache controlling section adapted to manage said cache memory using said tag memory and utilize said cache memory by a write-through method; and wherein
said cache controlling section includes:
a supervising section adapted to supervise accessing time to said cache memory; and
a refreshing section adapted to read out data on one or more cache lines of said cache memory from said main memory again and retain the read out data into said cache memory in response to a result of the supervision by said supervising section, and retain the read out data into said cache memory.

11. The information processing apparatus as claimed in claim 10, wherein said supervising section includes:
a timestamp issuance section adapted to write, when data is read out from said main memory and retained into said cache memory, a timestamp indicative of retention time of the data on the cache line or lines of said cache memory, which are a retention destination of the data, into said tag memory; and
a comparison section adapted to compare, at a point of time at which it is recognized based on tag information in said tag memory that target data of memory accessing by said processing section is retained in said cache memory, the retention time indicated by the timestamp regarding the cache line or lines which retain the target data and the present time with each other, and output, as a result of the supervision, a result of the comparison regarding whether or not the present time indicates lapse by predetermined time or more than the predetermined time after the retention time, and
where the supervision result from said supervising section indicates that the present time indicates lapse by the predetermined time or more than the predetermined time after the retention time, said refreshing section reads out the target data on the cache line or lines from said main memory again and retains the read out target data into said cache memory.

12. The information processing apparatus as claimed in claim 10, wherein said supervising section includes:
a timestamp issuance section adapted to write, when data is read out from said main memory and retained into said cache memory, a timestamp indicative of retention time of the data on the cache line or lines of said cache memory, which are a retention destination of the data, into said tag memory; and
a comparison section adapted to compare the retention time indicated by the timestamp regarding each cache line of said cache memory and the present time with each other and output, as a result of the supervision, a result of the comparison regarding whether or not the present time indicates lapse by predetermined time or more than the predetermined time after the retention time, and
where the supervision result from said supervising section indicates that the present time indicates lapse by the predetermined time or more than the predetermined time after the retention time, said refreshing section reads out the data on the cache line from said main memory again and retains the readout data into said cache memory.

13. The information processing apparatus as claimed in claim 12, wherein, where the supervision result from said supervising section indicates that the present time indicates lapse by the predetermined time or more than the predetermined time after the retention time, said refreshing section invalidates the cache line.

14. The information processing apparatus as claimed in claim 10, wherein said supervising section includes:
a timestamp issuance section adapted to write, when data is read out from said main memory and retained into said cache memory, a timestamp indicative of retention time of the data on the cache line or lines of said cache memory, which are a retention destination of the data, into said tag memory; and
a comparison section adapted to compare, at a point of time at which it is recognized based on tag information in said tag memory that the target data of memory accessing by said processing section is retained in said cache memory, the retention time indicated by the timestamp regarding the cache line or lines which retain the target data and the present time with each other, and output, as a result of the supervision, a result of the comparison regarding whether or not the present time indicates lapse by predetermined time or more than the predetermined time after the retention time, and
where the supervision result from said supervising section indicates that the present time indicates lapse by the predetermined time or more than the predetermined time after the retention time, said refreshing section reads out the target data on the cache line or lines from said main memory again and retains the read out target data into said cache memory and then invalidates all cache lines other than the cache line.

15. The information processing apparatus as claimed in claim 10, wherein said supervising section includes:
a time counting section adapted to count time; and
a comparison section adapted to compare the counted time by said time counting section and predetermined time with each other and output, as a result of the supervision, a result of the comparison regarding whether or not the counted time is equal to or longer than the predetermined time, and
where the supervision result from said supervising section indicates that the counted time is equal to or longer than the predetermined time, said refreshing section invalidates all cache lines of said cache memory.

16. The information processing apparatus as claimed in claim 11, wherein said cache memory is a static random access memory, and said refreshing section operates to prevent data in memory cells of said SRAM from being destroyed by a soft error by neutrons.

17. The information processing apparatus as claimed in claim 16, wherein the predetermined time used as a comparison reference by said comparison section is a time interval shorter than data destruct time before the data is destroyed by latchup of a thyristor structure which parasitically exists in a structure of the memory cells and is activated by the neutrons.

18. The information processing apparatus as claimed in claim 17, wherein the data destruct time is calculated based on node charge of the memory cells which retain the data and a resistance value of resistance through which leak current passes in the thyristor structure.

19. A computer-readable recording medium on or in which a cache controlling program for causing a computer to function as a cache controlling apparatus for managing a cache memory for temporarily retaining data read out from a main memory so as to be used by a processing section using a tag memory and for utilizing the cache memory by a write-through method is recorded, the cache controlling program causing the computer to function as:
a supervising section adapted to supervise accessing time to the cache memory; and
a refreshing section adapted to read out data on one or more cache lines of the cache memory from the main memory again in response to a result of the supervision by the supervising section, and retain the read out data into the cache memory.

20. The computer-readable recording medium on or in which the cache controlling program is recorded as claimed in claim 19, wherein the cache controlling program causes the computer to function as:
a timestamp issuance section adapted to write, when data is read out from the main memory and retained into the cache memory, a timestamp indicative of retention time of the data on the cache line or lines of the cache memory, which are a retention destination of the data, into the tag memory; and
a comparison section adapted to compare, at a point of time at which it is recognized based on tag information in the tag memory that target data of memory accessing by the processing section is retained in the cache memory, the retention time indicated by the timestamp regarding the cache line or lines which retain the target data and the present time with each other, and output, as a result of the supervision, a result of the comparison regarding whether or not the present time indicates lapse by predetermined time or more than the predetermined time after the retention time, and
when the cache controlling program causes the computer to function as the refreshing section, the cache controlling program causes the computer to function such that, where the supervision result from the supervising section indicates that the present time indicates lapse by the predetermined time or more than the predetermined time after the retention time, the refreshing section reads out the target data on the cache line or lines from the main memory again and retains the read out target data into the cache memory.
